(19) United States
(12) Patent Application Publication
(10) Pub. No.: US 2019/0128757 A1
(43) Pub. Date: May 2, 2019

(54) BRAKE TESTING SYSTEM FOR TESTING A BRAKE FOR A VEHICLE

(71) Applicant: ZF Friedrichshafen AG, Friedrichshafen (DE)

(72) Inventor: Christian HELL, Untergriesbach (DE)

(21) Appl. No.: 16/309,270

(22) PCT Filed: May 9, 2017
(86) PCT No.: PCT/EP2017/060969

§ 371 Date: Dec. 12, 2018

(30) Foreign Application Priority Data
Jun. 13, 2016 (DE) 10 2016 210 440.3

(51) Int. Cl. G01L 5/28

(52) U.S. Cl. CPC G01L 5/28

(57) ABSTRACT

A brake testing system (1) for testing a brake for a vehicle having at least one drive device (4) for generating a drive torque and at least one centrifugal mass device (5). The drive device (4) is provided with at least one drive shaft (7) and transfers the drive torque, via the drive shaft (7), to the centrifugal mass device (5). At least one retaining device (3) for retaining a brake element of the brake. The centrifugal mass device (5) is provided with at least one output shaft (8) and transfers the drive torque, via the output shaft (8), towards the retaining device (3). The brake testing system (1) is provided with at least one gear device (6) for the purpose of changing the gear ratio and the gear device (6) is disposed between the centrifugal mass device (5) and the retaining device (3).

This application is a National Stage completion of PCT/EP2017/060969 filed May 9, 2017, which claims priority from German patent application serial no. 10 2016 210 440.3 filed Jun. 13, 2016.

### FIELD OF THE INVENTION

The invention concerns a brake testing system for testing a brake for a vehicle, comprising at least one drive device for generating a drive torque, with at least one centrifugal mass device, wherein the drive device is provided with at least one drive shaft, wherein the drive device transfers the drive torque via the drive shaft to the centrifugal mass device, with at least one retaining device for retaining a brake element of the brake, wherein the centrifugal mass device is provided with at least one output shaft, wherein the centrifugal mass device transfers the drive torque via the output shaft in the direction of the retaining device.

### BACKGROUND OF THE INVENTION

When developing brake systems for vehicles, centrifugal mass test rigs are used to test the braking characteristics. The brake test rigs are required to simulate a mass inertia of up to several 1000 kgm² with their drive train. This is achieved by using different centrifugal masses in combination with an electric drive. The different mechanical centrifugal masses are located directly in the drive train and are coupled to the drive train as required.

The document DE 69 201 306 T2 describes a brake testing mechanism with facilities for generating a rotational centrifugal mass movement, a wheel element that is attached to the rotational centrifugal mass movement device, and devices for braking the wheel element, which include brake bad absorbing devices. The brake testing mechanism is provided with devices for generating an oscillating movement of the brake bad absorbing device, and devices to control the test mechanism and for data acquisition, so that by the rotation of the wheel element by the centrifugal mass rotating device and by the operation of the oscillating movement devices for oscillating movement of the brake load absorbing device during operation of the brake device, data concerning the functionality of the brake device can be acquired. The centrifugal mass section comprises a plurality of large, heavy flywheels or disks as they are typically used in dynamometers.

The document EP 2 431 316 A1 discloses a device and a method for testing brake performance. The device comprises a drive unit that generates energy, a test unit that is driven by the drive unit and a control unit, which controls the operation of the brake device in order to generate a braking force on the test unit and to ascertain the brake performance. A drive power is generated by two separate drive units and transferred by means of a belt drive to the test unit.

The document U.S. Pat. No. 3,577,777 A1 describes a test rig for brakes in which the brakes to be tested are loaded with energy from rotating mass elements. The rotating masses are in this instance disposed on different shafts, which may be connected amongst each other through clutches as well as a fixed gear box ratio. Through the closing and opening of clutches it is therefore possible to set, in a simple manner, the overall mass, and thus the overall energy, with which the brakes are loaded.

### SUMMARY OF THE INVENTION

It is the object of the invention to propose a brake testing system for testing a brake for a vehicle that offers simple operation in combination with a compact design.

The object is met by a brake testing system with the characteristics of the independent claims, Preferred or advantageous embodiments of the invention become apparent from the dependent claims, the following description and/or the attached drawings.

According to the invention a brake testing system for testing a brake for a vehicle is proposed. The brake testing system is designed in particular as a test rig. The brake to be tested is in particular a friction brake, preferably a disk brake and/or a drum brake. The brake test rig is designed in particular for testing the brake of a commercial vehicle and/or a rail vehicle and/or a motor vehicle.

The brake testing system is provided with at least one drive device for generating a drive torque. The drive device is in particular a machine, preferably an electrical machine or an electromotor. The drive device has in particular a torque of more than 2000 Nm, preferably more than 6000 Nm, in particular more than 10,000 Nm. Alternatively, or optionally complementing, the drive device has a torque of less than 8000 Nm, preferably less than 4000 Nm, in particular less than 1000 Nm.

The drive device provides in particular a rotational speed of more than 2000 rpm, preferably more than 5000 rpm, in particular more than 10,000 rpm. Alternatively, or optionally complementing, the drive device provides a rotational speed of less than 7000 rpm, preferably less than 3000 rpm, in particular less than 1500 rpm. The torque and the speed of the drive device are in particular infinitely variable or adjustable in multiple steps.

The drive device may advantageously be used to drive two brake testing systems according to the invention simultaneously. In particular when the drive device is designed as an electrical machine or as an electromotor, a motor shaft or drive shaft respectively may, for example, extend in both axial directions from the drive device so that the motor shaft or drive shaft respectively drives a brake testing system with each of its axial ends.

The brake testing system is provided with at least one centrifugal mass device. The centrifugal mass device has in particular the function of applying a defined centrifugal mass to a rotating brake element so that, particularly preferred, different kinetic energy states can be simulated. In particular at least the weight force of a vehicle, which acts on the brake, is simulated.

The drive device is provided with at least one drive shaft, wherein the drive device transfers the drive torque via the drive shaft to the centrifugal mass device. In particular, the drive shaft transfers rotational movement to the at least one centrifugal mass device. The drive shaft defines in particular a main rotational axis. The drive shaft with its longitudinal axis or its rotational axis preferably defines the main rotational axis.

The brake testing system is provided with at least one retaining device for retaining at least one brake element. The retaining device has in particular the function to simulate a braking process and preferably acquire certain measurement values. The brake element is in particular a brake disk and/or a track wheel and/or a brake drum and/or a shoe brake and/or a hydraulic brake, for example a so-called retarder. The retaining device is preferably provided with a brake device for applying a frictional force to the brake element. The brake device comprises in particular at least one brake shoe and/or a brake lining, which is preferably in frictional contact with the brake element during the braking process. The retaining device comprises in particular at least one acquisition device for the acquisition of a rotational speed and/or a torque and/or a temperature.

The centrifugal mass device is provided with an output shaft, wherein the centrifugal mass device transfers the drive torque via the output shaft to the at least one retaining device. The output shaft is in particular coupled, and/or able to be coupled, torque-proof with the drive shaft. The output shaft preferably forms an axial extension in relation to the main rotational axis of the drive shaft. In particular, the output shaft has the same outer diameter as the drive shaft. Alternatively, the drive shaft and the output shaft have different outer diameters.

As part of the invention it is proposed that the brake testing system is provided with gear device for changing the gear ratio. The gear device has in particular the function to simulate different mechanical centrifugal masses, so that for each change in gear ratio preferably a change in a virtual mass moment of inertia occurs at the retaining device. In particular the gear device simulates different weight forces, preferably different types of vehicles, which act on the brake element. The change in the virtual mass moment of inertia corresponds in particular to a change in rotational energy. The gear device in particular takes the form of a switchable gear device.

The gear device is disposed between the centrifugal mass device and the at least one retaining device. The gear device has in particular a geared connection with the retaining device and/or the gear device. A torque path extends in particular from the drive device via the centrifugal mass device, via the gear device to the retaining device.

The advantage of the invention lies in the fact that in particular a fully automatic centrifugal mass adjustment can be achieved without the time-consuming manual or automatic coupling of centrifugal masses with the drive train. Since the gear ratio in the consideration of mass inertia is squared, the installed mechanical centrifugal mass can be significantly smaller. This is of particular advantage since an effective operation of the brake testing system is already possible by using a single mechanical centrifugal mass, and the centrifugal mass adjustment is achieved through the different gear speeds. A further advantage is, therefore, that the brake testing system can be made into a compact unit and also made very cost-effectively since large centrifugal masses are not required. Since it is possible to limit the centrifugal mass to a single unit, the design of the drive train can be much simpler so that it is no longer necessary to handle centrifugal masses and/or provide oil bearings and/or an emergency brake and/or an additional drive and/or an access cabin. This makes for a particularly convenient and easy to operate brake testing system. Nevertheless, it is of course possible to operate the brake testing system according to the invention with more than a single centrifugal mass.

In a preferred embodiment of the invention the output shaft is connected to the gear device, wherein the output shaft transfers an input torque to the gear device. The output shaft has in particular a torque-proof connection with a gear element, for example a gear wheel, inside the gear device so that the input torque is transferred to the gear wheel.

The gear device is provided with a power take-off shaft, wherein the power take-off shaft transfers output torque to the at least one retaining device. The power take-off shaft has in particular a torque-proof connection with an axial end to a further gear element inside the gear device. In particular, an oppositely-located axial end is attached torque-proof to the retaining device so that preferably the output torque is transferred to the retaining device and thus specifically to the brake element.

The gear device sets different gear ratios. The gear device is provided in particular with more than one different gear ratio, preferably more than three, particularly preferred more than five, specifically more than ten different gear ratios. The gear device is provided in particular with at least two different gears, preferably at least three different gears, particularly preferred at least four different gears, specifically more than six different gears. Each gear in particular has a different gear ratio, wherein the corresponding virtual mass moment of inertia is preferably simulated with each gear ratio.

Examples for possible, virtual mass moments of inertia of a gear device with four gears are, based upon a real mass moment of inertia in the centrifugal mass device of 222 kgm², for example:

| Gear ratio | Mass moment of inertia |
|---|---|
| i = 1.5 | 500 kgm² |
| i = 2.12 | 1000 kgm² |
| i = 2.6 | 1500 kgm² |
| i = 3 | 2000 kgm² |

The speed of the power take-off shaft is in particular different or the same as the speed of the output shaft and/or the drive shaft. In particular, the output shaft rotates at a first rotational speed and the power take-off shaft at a second rotational speed. In particular when idling, the first rotational speed is equal to the second rotational speed, wherein the virtual mass moment of inertia at the brake element preferably corresponds with the mass moment of inertia at the centrifugal mass device. In particular the second rotational speed is a constant rotational speed, wherein the first rotational speed preferably varies. In particular the second rotational speed is constant when changing the gear ratio by way of the gear device, preferably equal to the second rotational speed when idling. In particular, when changing the gear ratio by way of the gear device, the first rotational speed is higher or lower than the rotational speed when idling and/or higher or lower than the second rotational speed.

The second rotational speed in particular is 6000 rpm. Alternatively or optionally complementing, the second rotational speed is reduced specifically in a testing process or braking process respectively so that the brake element is preferably brought to a stand-still.

In actual implementation, the gear device used is a gear transmission or a traction drive. The gear transmission is in particular a spur gear and/or a bevel gear and/or a planetary gear. The traction drive is in particular a force-locked and/or a form-locked traction drive. For example in a single-station operation the gear device used is a spur gear. The gear device used in particular in a multi-station operation is a bevel gear. Nevertheless, even if the gear device takes the form of a bevel gear, the brake testing system may still be used in a single-station operation.

In a further preferred embodiment the selection of the different gear ratios is either infinitely variable or stepped. The infinitely variable selection of the gear ratio is achieved in particular through the traction drive, wherein preferably any number of gear ratios may be selected. The stepped, preferably multi-stepped, selection of the gear ratio is achieved in particular through the gear transmission. The selection of the gear ratio is achieved in particular through a change of gears.

In a possible embodiment the gear device is provided with a further drive device. The further drive device has in particular the purpose of providing particularly high torque values via a gear arrangement designed for this purpose, and may be used for high-torque testing, for example to simulate the breaking free of the drive train from a blocked brake. The further drive device is in particular a three-phase machine and/or an electromotor. The further drive device transfers an additional drive torque to the gear device.

In an alternative implementation the gear device is provided with at least one further power take-off shaft. The gear device takes, in particular, the form of a bevel gear. The gear device is provided in particular with more than one, preferably more than two, specifically more than three power take-off shafts. Nevertheless, particularly preferred is that the gear device is provided with exactly two power take-off shafts. Alternatively the brake testing system is provided with at least one power, divider, wherein the power divider has preferably at least two power take-off shafts. In particular the power divider is coupled and/or may be coupled with the gear device. Alternatively the power divider is part of the gear device or forms the gear device. The power divider is, for example, a transfer case.

The gear device transfers the output torque via the further power take-off shaft to at least one further retaining device in parallel or alternating to the retaining device. The further retaining device is in particular designed to retain a further brake element. The brake element and the further brake element have the same or a different design. The further retaining device can in particular be uncoupled from the retaining device so that preferably the retaining device can be fitted simultaneously to the second retaining device or the second retaining device can be fitted simultaneously to the retaining device, particularly preferable whilst one of the retaining devices is in operation. Alternatively or optionally complementing, both retaining devices can be operated in parallel dependent or independent from each other.

In a further embodiment the gear device is provided with an actuating element, wherein the actuating element switches automatically and/or automated between the different gear ratios. The actuating element may in particular be controlled remotely so that, preferably, during the test process the different gear ratios can be selected from a central or decentral control module. The actuating element is in particular programmable so that, for example, certain test cycle times can be set, wherein the actuating element switches preferably after completion of the predetermined test cycle time into the next higher or lower gear ratio step. Alternatively, in the instance of an infinitely variable selection of the gear ratios, a constant increase or reduction of the gear ratio is possible so that, for example, over the course of the predetermined test cycle time the gear ratio is changeable. The gear device takes, for example, the form of an automatic transmission. Alternatively the actuating element may be operated manually. In particular, the actuating element takes the form of a kind of gear lever to preferably be able to select different gears.

In a further preferred embodiment the centrifugal mass device is provided with at least one centrifugal element. The centrifugal mass element is in particular a kind of energy store for the kinetic energy. The centrifugal mass element is in particular a flywheel. The centrifugal mass element has in particular a diameter of more than 100 mm, preferably more than 500 mm, specifically more than 1000 mm. Alternatively, or optionally complementing, the centrifugal mass element has a diameter of less than 2000 mm, preferably less than 900 mm, specifically less than 300 mm.

The centrifugal mass element has in particular a length of more than 100 mm, preferably more than 500 mm, specifically more than 1000 mm. Alternatively, or optionally complementing, the centrifugal mass element has a length of less than 2000 mm, preferably less than 900 mm, specifically less than 300 mm.

The centrifugal mass element has in particular a mass moment of inertia of more than 100 kgm², preferably more than 300 kgm², specifically 600 kgm², Alternatively, or optionally complementing, the centrifugal mass element has a mass moment of inertia of less than 1000 kgm², preferably less than 500 kgm², specifically less than 200 kgm². However, it is particularly preferred that the centrifugal mass element has a diameter of approximately 800 mm, a length of approximately 700 mm as well as a mass moment of inertia of 222 kgm².

A combination of two centrifugal mass elements is also possible and preferred. In this way it is possible, for example, to achieve an increased total mass moment of inertia.

The drive shaft is attached to the centrifugal mass element and imparts rotational movement to it. The centrifugal mass element has in particular a torque-proof connection with the drive shaft. Alternatively, the drive shaft and the output shaft form a common shaft. The centrifugal mass element is preferably connected to the drive shaft and/or output shaft form-locked and/or force-locked and/or friction-locked and/or by means of bonding.

In an actual embodiment the brake testing system is provided with at least one bearing device, wherein the bearing device supports the centrifugal mass element. The brake testing system is provided in particular with exactly two bearing devices. Alternatively, the brake testing device is provided in particular with more than two, specifically more than four bearing devices. The bearing device is in particular a spindle bearing, for example an angular ball bearing. The bearing device is in particular lubricated, for example oil-lubricated but preferably grease-lubricated.

In a further implementation the drive device and/or the further drive device is a three-phase machine. The drive device is in particular an asynchronous motor, preferably a 4-pole three-phase asynchronous motor.

### BRIEF DESCRIPTION OF THE DRAWINGS

Further characteristics, advantages and effects of the invention become apparent from the following description of preferred exemplary embodiments of the invention. Shown are in:

FIG. 1 a schematic representation of the brake testing system as one exemplary embodiment of the invention;

FIG. 2 a plan view of the brake testing system with a first and a second retaining device.

### DETAILED DESCRIPTION OF THE PREFERRED EMBODIMENTS

Corresponding parts or parts that are the same in the Figures have each been given the same reference number.

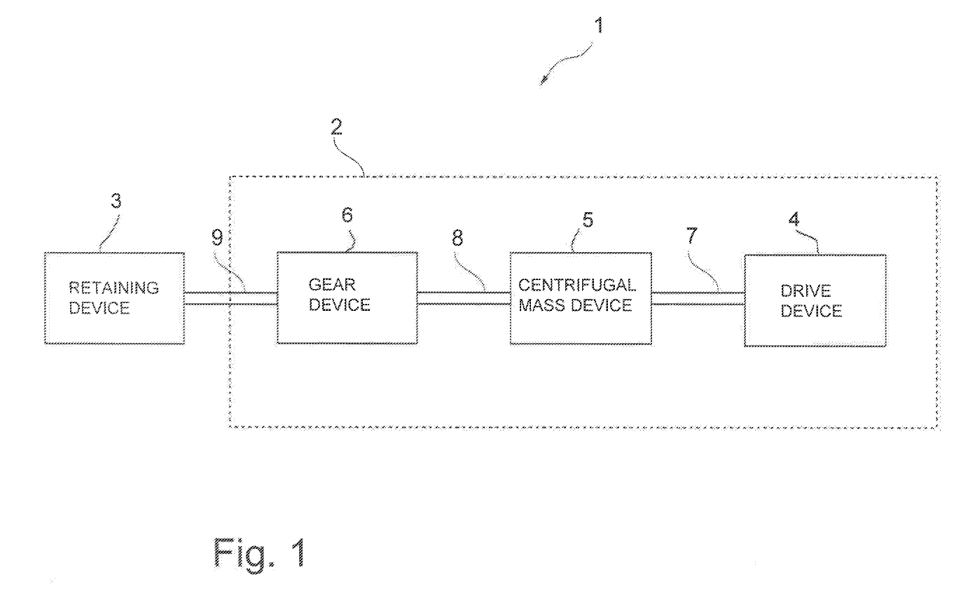

FIG. 1 depicts a very simplified schematic representation of a brake testing system 1. The brake testing system 1 comprises a drive train 2 for a retaining device 3. The retaining device 3 is suitable for retaining a brake element, for example a brake disk, wherein the retaining device 3 is provided with at least one brake device, for example brake pads. The retaining device 3 simulates, for example, a braking process so that the brake device applies a frictional force onto the brake element.

The drive train 2 comprises a drive device 4, a centrifugal mass device 5 and a gear device 6. The drive device 4, for example a three-phase machine, is connected to the centrifugal mass device 5 via a drive shaft 7 through gears. The drive device 4 transfers drive torque or rotational speed respectively to drive shaft 7 and thus to the centrifugal mass device 5.

The centrifugal mass device 5 is connected to the gear device 6 via an output shaft 8 by means of gears. The centrifugal mass device 5 transfers an input torque to output shaft 8 and thus to the gear device 6. The centrifugal mass device 5 increases the rotational energy of the brake disk element. For example, the centrifugal mass device 5 simulates a weight force of a vehicle, which acts on the brake disk during the braking process.

The gear device 6 is, for example, a spur gear that sets different gear ratios. Since the gear ratio in the consideration of mass inertia is squared, it is possible to simulate different centrifugal masses with different mass moments of inertia by means of the gear device 6. The gear device 6 is connected via a power take-off shaft 9 with the retaining device 3 by means of gears. An output torque is transferred to the retaining device 3 or the brake disk respectively via the power take-off shaft 9 so that the brake disk rotates at a certain rotational speed.

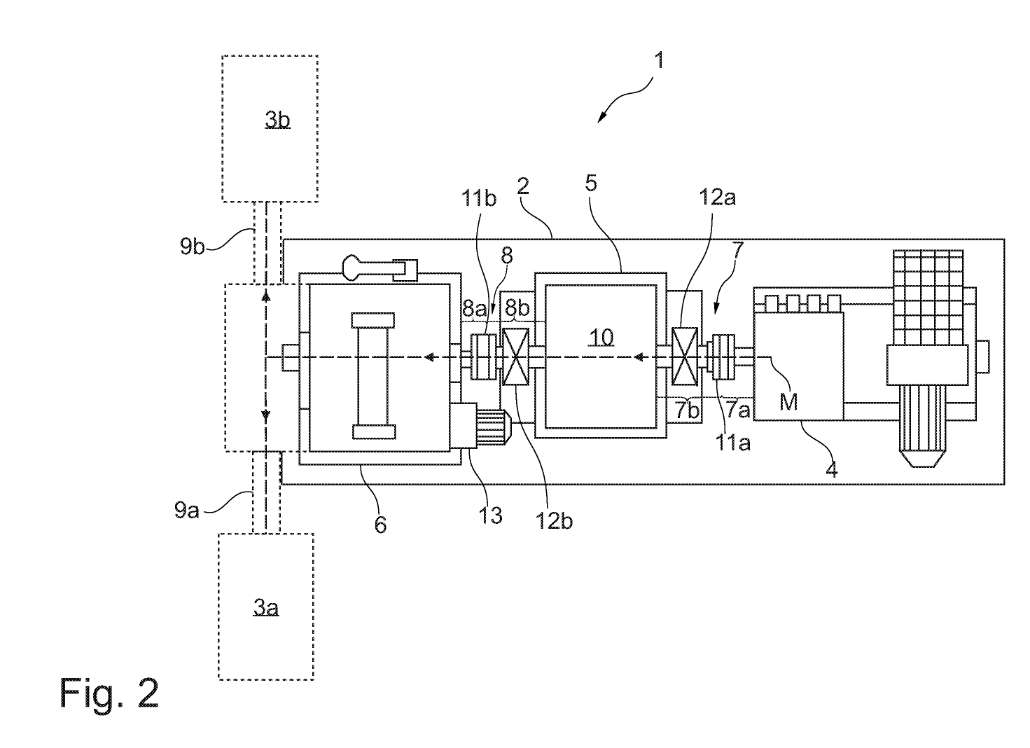

FIG. 2 depicts the brake testing system 1 in plan view. The drive train 2 comprises a drive device 4, for example a three-phase asynchronous machine, wherein the drive device 4 is connected to a centrifugal mass element 10 via drive shaft 7. The centrifugal mass element 10 is, for example, a flywheel with a diameter of, for example, approximately 800 mm and/or a length of, for example, approximately 700 mm and/or a mass moment of inertia of, for example, 222 kgm². The centrifugal mass element 10 is connected to the gear device 6 via the output shaft 8. The centrifugal mass element 10 is coupled torque-proof, for example by way of a force-fit and/or friction-locked and/or form-locked, to the drive shaft 7 and the output shaft 8.

The drive shaft 7 comprises a first and a second drive shaft section 7a, 7b, wherein both drive shaft sections 7a, 7b form the drive shaft 7. The first drive shaft section 7a is connected to the drive device 4. The second drive shaft section 7b is connected to the centrifugal mass element 10. The output shaft 8 comprises a first and a second output shaft section 8a, 8b, wherein both output shaft sections 8a, 8b form the output shaft 8. The first output shaft section 8a is connected to the gear device 6. The second drive shaft section 8b is connected to the centrifugal mass element 10.

The drive train 2 comprises a first and a second coupling device 11a, 11b. The coupling devices 11a, 11b allow for a quick exchange of the centrifugal mass element 10. Both drive shaft sections 7a, 7b are coupled to each other via the first coupling device 11a, For example the first coupling device 11a forms part of the drive shaft 7. Both output shaft sections 8a, 8b are coupled to each other via the second coupling device 11b. For example the second coupling device 11b forms part of the output shaft 8. In addition or alternatively to the coupling devices 11a, 11b one or more safety couplings may be provided which, however, are not shown in FIG. 2.

The centrifugal mass device 5 is provided with a first and a second bearing 12a, 12b. Both bearings 12a, 12b may, for example, be grease-lubricated spindle bearings. The first bearing 12a supports the drive shaft 7 or the second drive shaft section 7b respectively, which is connected to the centrifugal mass element 10. The second bearing 12b supports the output shaft 8 or the second output shaft section 8b respectively, which is connected to the centrifugal mass element 10.

The gear device 6 shown in FIG. 2 is designed, for example, as a bevel gear and is thus suitable for a single-station operation as well as for a two-station operation.

The gear device 6 is provided with a first and a second power take-off shaft 9a, 9b. The first power-take-off shaft 9a is connected to a first retaining device 3a. The second power-take-off shaft 9b is connected to a second retaining device 3b. Both retaining devices 3a, 3b are, for example, designed to retain the same or different brake elements.

The gear device 6 is provided with a further drive device 13. The further drive device 13 is connected to or integrated into the gear device 6 in such a way that a particularly high torque, for example for high-torque testing, is transferred to the gear device 6 and thus to the power take-off shaft 9 and the first and/or second power take-off shafts 9a, 9b respectively. It is possible, for example, to simulate the breaking-free of the brake with the further drive device 13.

A torque path extends from the drive device 4 via drive shaft 7, the centrifugal mass element 10, the output shaft 8, gear device 6 to the first and/or second power take-off shaft 9a, b and to the first and/or second retaining device 3a, 3b respectively.

The brake testing system 1 functions as follows:

The drive device 4 transfers rotational movement to drive shaft 7, through which a first rotational speed is established and/or selectable. The centrifugal mass 10 and the output shaft 8 are made to rotate at a first rotational speed via drive shaft 7. For example, the gear device 6 transfers the rotational movement with the first rotational speed to the power take-off shafts 9a, 9b. A second rotational speed is established at the power take-off shafts 9a, 9b.

With a first gear selection the torque path extends via the gear device 6, wherein the gear device 6 establishes a first gear ratio between the drive device 4 or the centrifugal mass element 10 respectively and the retaining devices 3a, 3b or the power take-off shafts 9a, 9b. For example the first rotational speed is equal to or greater than or smaller than the second rotational speed. For example, the first and/or the second take-off shaft 9a, 9b has in the first or in a further gear selection a greater mass inertia than the output shaft and/or the drive shaft.

In a specific exemplary embodiment of the invention the brake testing system 1 is designed for a two-station operation and is provided with the further drive device 13 that is integrated into the gear device 6. The centrifugal mass element 10 is supported by a grease-lubricated spindle bearing. The centrifugal mass element 10 has a diameter of 800 mm, a length of 700 mm and a mass moment of inertia of 222 kgm².

The drive device 4 is provided in form of a 4-pole PS drive with a torque of 3000 (6000) Nm and a speed of 6000 rpm. The gear device 6 is provided with four different gears, wherein the simulation matching occurs via the selectable gear ratios in the transmission. A first gear has a gear ratio of i=1.5 and simulates a mass moment of inertia of 500 kgm². A second gear has a gear ratio of i=2.12 and simulates a mass moment of inertia of 1000 kgm². A third gear has a gear ratio of i=2.6 and simulates a mass moment of inertia of 1500 kgm². A fourth gear has a gear ratio of i=3 and simulates a mass moment of inertia of 2000 kgm².

In a further exemplary embodiment that is not shown, the drive shaft 7 of the drive device 4 in FIG. 1 is designed such that, as per the representation in FIG. 1, it protrudes to the right from the drive device 4 in the same manner as to the left. With the part of the drive shaft 7 that protrudes to the right the drive device 4 powers a second brake testing system that is identical to the brake testing system 1 of FIG. 1. The selection of a further centrifugal mass device in the second brake testing system is optional and may not be used.

### LIST OF REFERENCE NUMBERS

1 Brake testing system
2 Drive train
3 Retaining device
3a First retaining device
3b Second retaining device
4 Drive device
5 Centrifugal mass device
6 Gear device
7 Drive shaft
8 Output shaft
9 Power take-off shaft
9a First power take-off shaft
9b Second power take-off shaft
10 Centrifugal mass element
11a First coupling device
11b Second coupling device
12a First bearing
12b Second bearing
13 Further drive device

1-13. (canceled)

14. A brake testing system (1) for testing a brake for a vehicle, the brake testing system comprising:
at least one drive device (4) for generating a drive torque, with at least one centrifugal mass device (5),
the drive device (4) being provided with at least one drive shaft (7),
the drive device (4) transferring the drive torque, via the drive shaft (7), to the centrifugal mass device (5),
at least one retaining device (3) for retaining a brake element of the brake,
the centrifugal mass device (5) being provided with at least one output shaft (8), and the centrifugal mass device (5) transferring the drive torque, via the at least one output shaft (8), towards the retaining device (3),
the brake testing system (1) being provided with at least one gear device (6) having changeable gear ratios,
the gear device (6) being disposed between the centrifugal mass device (5) and the retaining device (3),
the gear device (6) being provided with at least one further drive device (13), and
the further drive device (13) transfers an additional drive torque to the gear device (6).

15. The brake testing system (1) according to claim 14, wherein the at least one output shaft (8) is operatively connected to the gear device (6), the at least one output shaft (8) transfers an input torque to the gear device (6), the gear device (6) is provided with at least one power take-off shaft (9), the power take-off shaft (9) transfers an output torque to the at least one retaining device (3), and the gear device (6) establishes different gear ratios between the input torque and the output torque.

16. The brake testing system (1) according to claim 14, wherein the gear device (6) being either a gear transmission or a traction drive.

17. The brake testing system (1) according to claim 14, wherein selection of at least two different gear ratios is either infinitely variable or in steps.

18. The brake testing system (1) according to claim 14, wherein the gear device (6) is provided with exactly four different gears with four different gear ratios, and the four different gear ratios range from i=1 to i=4.

19. The brake testing system (1) according to claim 14, wherein the gear device (6) is provided with at least one further drive shaft, and the gear device (6) transfers the output torque, via the further drive shaft, to at least one further retaining device either parallel or alternatingly to the retaining device.

20. The brake testing system (1) according to claim 14, wherein the gear device (6) is provided with an actuating element, and the actuating element at least one of switches automatically and automated between the different gear ratios.

21. The brake testing system (1) according to claim 14, wherein the centrifugal mass device (5) comprises at least one centrifugal mass element (10), and the drive shaft (7) is operatively connected to the centrifugal mass element (10) and causes the centrifugal mass element (10) to rotate.

22. The brake testing system (1) according to claim 21, wherein a mass moment of inertia of the centrifugal mass element (10) is less than 300 kgm².

23. The brake testing system (1) according to claim 14, wherein the brake testing system (1) is provided with at least one bearing device (12a, 12b), and the bearing device (12a, b) supports the centrifugal mass element (10).

24. The brake testing system (1) according to claim 23, wherein the at least one bearing device (12a, b) is a spindle bearing.

25. The brake testing system (1) according to claim 14, wherein at least one of the drive device (4) and the further drive device (13) is a three-phase machine.

26. A brake testing system for testing brakes of a vehicle, the brake testing system comprising:
at least one drive device having at least one drive shaft which is drivingly coupled to at least one centrifugal mass device,
the drive device rotationally driving the centrifugal mass device with the drive shaft,
the centrifugal mass device having at least one output shaft which is drivingly coupled to at least one gear device,
the centrifugal mass device transferring rotational drive, via the at least one output shaft, to the gear device,
the gear device having a power take-off shaft which is drivingly couples a retaining device to which at least one brake element of the brakes to be tested is mounted,
the gear device having a plurality of changeable gear ratios and a further drive device such that the gear device transmits the rotational drive, via the power take-off shaft and the retaining device, to the at least one brake element of the brakes to be tested from at least one of the centrifugal mass device and the further drive device.
